(19) United States
(12) Patent Application Publication
(10) Pub. No.: US 2026/0338681 A1
(43) Pub. Date: Oct. 29, 2026

(54) FORMING METHOD OF ASBESTOS IDENTIFICATION MODEL, ASBESTOS RAPID SCREENING SYSTEM AND DETECTION METHOD THEREOF

(71) Applicant: InnoSpectra Corporation, Hsin-Chu (TW)

(72) Inventors: Hsi-Pin Li, Hsin-Chu (TW); Yung-Yu Huang, Hsin-Chu (TW); Pei-Ying Lin, Hsin-Chu (TW); Fei-Peng Chang, Hsin-Chu (TW)

(73) Assignee: InnoSpectra Corporation, Hsin-Chu (TW)

(21) Appl. No.: 19/635,802

(22) Filed: Apr. 1, 2026

(30) Foreign Application Priority Data
Apr. 23, 2025 (CN) 202510513324.3

(51) Int. Cl. G01N 21/3563; G01J 3/12; G01J 3/28; G01N 21/01; G01N 21/359

(52) U.S. Cl. CPC G01N 21/3563; G01J 3/12; G01J 3/28; G01N 21/01; G01N 21/359; G01J 2003/1204; G01J 2003/284; G01J 2003/2843; G01N 2021/0137

(57) ABSTRACT

A forming method of an asbestos identification model, an asbestos rapid screening system, and a detection method thereof are provided, wherein the method for forming the asbestos identification model includes the following steps: Providing multiple samples, wherein a portion of the samples contain asbestos, and another portion of the samples do not contain asbestos. Establishing multiple first spectral data of the samples using a spectrometer. Performing a cubic spline resampling step and a wavelength selection step on the multiple first spectral data to obtain multiple second spectral data. Performing a spectral differentiation and smoothing step and a scattering correction step on the multiple second spectral data to obtain multiple third spectral data. Performing a principal component analysis step on the multiple third spectral data to obtain multiple fourth spectral data. Performing a nonlinear classification step on the multiple fourth spectral data to establish the asbestos identification model.

### CROSS-REFERENCE TO RELATED APPLICATION

This application claims the priority benefit of China application serial no. 202510513324.3, filed on Apr. 23, 2025. The entirety of the above-mentioned patent application is hereby incorporated by reference herein and made a part of this specification.

### BACKGROUND

### Technical Field

The disclosure relates to a spectral scanning system and a detection method thereof, and in particular relates to a forming method of an asbestos identification model, an asbestos rapid screening system and a detection method thereof.

### Description of Related Art

Asbestos possesses multiple properties, including fire resistance, high temperature resistance, insulation, abrasion resistance, acid and alkali resistance, corrosion resistance, high tensile strength, fiber softness, flexibility, and spinnability. Due to these properties, asbestos has been extensively utilized in various products, such as cement products, textiles, wear-resistant materials, and insulation products.

The International Agency for Research on Cancer under the World Health Organization has classified asbestos as a Group 1 carcinogen, indicating sufficient evidence that it causes tumors in humans. Furthermore, the National Institute for Occupational Safety and Health under the Centers for Disease Control and Prevention in the United States also recognizes asbestos as a potential carcinogen. Exposure to asbestos may also cause other diseases, including asbestosis (pulmonary fibrosis), pleural plaques, pleural thickening, and pleural effusion.

Asbestos-related products remain ubiquitous to this day. For example, asbestos was extensively used in early construction materials, so many older buildings still contain asbestos materials. To ensure the safe handling and disposal of existing asbestos waste, comprehensive testing and confirmation of the presence or absence of asbestos is necessary.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

A forming method of an asbestos identification model, an asbestos rapid screening system and a detection method thereof, which may quickly and accurately perform a qualitative analysis of asbestos to confirm the presence or absence of asbestos in an object to be tested, are provided in the disclosure.

The other objectives and advantages of the disclosure may be further understood from the descriptive features disclosed in the disclosure.

In order to achieve one of, or portions of, or all of the above objectives or other objectives, at least one embodiment of the disclosure provides a forming method of an asbestos identification model, which includes the following steps. Multiple samples are provided, in which a portion of the samples contain asbestos, and another portion of the samples do not contain asbestos. Multiple first spectral data of the samples are respectively established using a spectrometer, in which each of the samples corresponds to a corresponding one of the first spectral data. A cubic spline resampling step and a wavelength selection step are performed on the first spectral data to obtain multiple second spectral data, in which a wavelength range selected in the wavelength selection step is between 1300 nanometers and 1500 nanometers. A spectral differentiation and smoothing step and a scattering correction step are performed on the second spectral data to obtain multiple third spectral data, in which the scattering correction step is performed before or after the spectral differentiation and smoothing step. A principal component analysis step is performed on the third spectral data to obtain multiple fourth spectral data. A nonlinear classification step is performed on the fourth spectral data to establish the asbestos identification model.

An asbestos rapid screening system including a spectrometer and a storage device is provided in at least one embodiment of the disclosure. The spectrometer includes a scanning window, a light source, a diffraction grating, a wavelength selector, a photodetector, and a light absorbing element. The light source is configured to provide light to an object to be tested above the scanning window. At least a portion of the light is reflected by the object to be tested and then passes through the diffraction grating and the wavelength selector in sequence, and the photodetector and the light absorbing element are configured to receive light from the wavelength selector. The storage device is communicatively connected to the spectrometer. The storage device includes an asbestos identification model, and the asbestos identification model includes asbestos data processed by nonlinear classification.

A detection method of an asbestos rapid screening system is provided in at least one embodiment of the disclosure, the detection method includes the following operation. An asbestos rapid screening system is provided. An object to be tested is placed above a scanning window of the asbestos rapid screening system. Spectral data of the object to be tested is obtained using a spectrometer of the asbestos rapid screening system. The spectral data of the object to be tested is identified using an asbestos identification model to determine whether the object to be tested contains asbestos.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of an asbestos rapid screening system according to an embodiment of the disclosure.

FIG. 2 is a schematic diagram of an asbestos rapid screening system according to another embodiment of the disclosure.

FIG. 3 is a schematic diagram of the interior of a spectrometer of an asbestos rapid screening system according to an embodiment of the disclosure.

FIG. 4 is a schematic diagram of the transmission of sub-diffuse reflected lights.

FIG. 5 is a schematic diagram of a wavelength selector controlling the deflection of its micro-mirrors at different timings.

FIG. 6 is a flowchart of a detection method of an asbestos rapid screening system of an embodiment of the disclosure.

FIG. 7 is a flowchart of a forming method of an asbestos identification model of an embodiment of the disclosure.

FIG. 8A is first spectral data of samples of some embodiments of the disclosure.

FIG. 8B shows third spectral data obtained after the first spectral data of FIG. 8A undergoes cubic spline resampling, a wavelength selection step, a spectral differentiation and smoothing step, and a scattering correction step.

FIG. 8C shows a distribution diagram of multiple fourth spectral data with the principal component PC1 as the horizontal axis and the principal component PC2 as the vertical axis.

FIG. 8D shows a distribution diagram of multiple fourth spectral data with the principal component PC2 as the horizontal axis and the principal component PC3 as the vertical axis.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

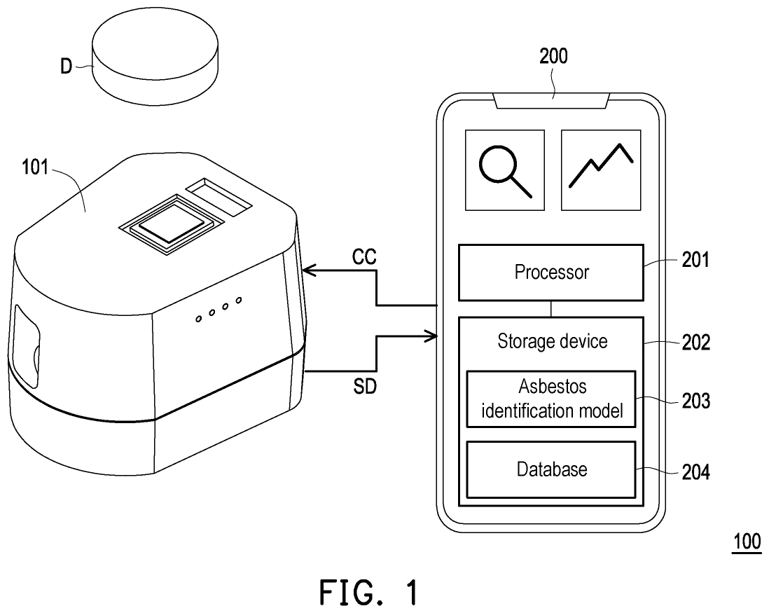

FIG. 1 is a schematic diagram of an asbestos rapid screening system 100 according to an embodiment of the disclosure. Referring to FIG. 1, an embodiment of the disclosure provides an asbestos rapid screening system 100. The asbestos rapid screening system 100 includes a spectrometer 101 and an operating device 200. The operating device 200 is electrically connected to the spectrometer 101. In some embodiments, the size of the spectrometer 101 is approximately 93.5 mm×76 mm×73 mm.

The operating device 200 is configured to issue a control command CC to enable the spectrometer 101 to scan the object to be tested D to obtain spectral data SD of the object to be tested D. The spectrometer 101 is configured to generate the spectral data SD of the object to be tested D and transmit the spectral data SD to the operating device 200. In some embodiments, the operating device 200 is a mobile device, such as a smartphone, a tablet, a laptop, but not limited thereto. In another embodiment, the operating device 200 may also be a fixed device such as a desktop computer or a remote operating device. In other embodiments, the operating device 200 and the spectrometer 101 are integrated into the same device. The operating device 200 includes a processor 201 and a storage device 202. The processor 201 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. The processor 201 may be coupled to the storage device 202, and access and execute modules, programs or applications stored in the storage device 202. The storage device 202 may be a computer-readable medium, such as any type of fixed or removable random access memory (RAM), read-only memory (ROM), flash memory, hard disk drive (HDD), solid state drive (SSD), or similar elements, or a combination of the elements thereof configured to store modules, programs, or applications executable by the processor 201. In this embodiment, the storage device 202 includes an application, the application has a menu interface, and the processor 201 may execute various functions of the application. In some embodiments, the storage device 202 has an asbestos identification model 203. The asbestos identification model 203 is a software program. The processor 201 may execute the asbestos identification model 203 to identify the spectral data SD of the object to be tested D. In addition, the storage device 202 may further include a database 204 for storing spectral data SD of various samples.

After the spectral data SD of the object to be tested D is identified by using the asbestos identification model 203, it may be determined whether the object to be tested D contains asbestos. The operating device 200 uses a display screen to display an identification result to a tester.

In this embodiment, the storage device 202 including the asbestos identification model 203 is communicatively connected (e.g., wired or wirelessly connected) to the spectrometer 101 and is disposed in the operating device 200 (e.g., a mobile device) to perform asbestos identification in the operating device 200.

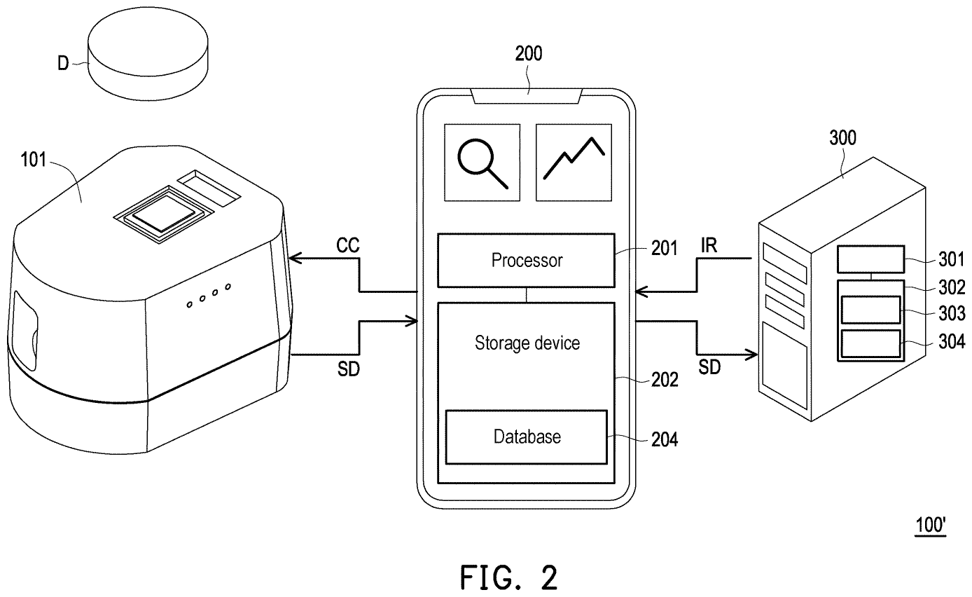

FIG. 2 is a schematic diagram of an asbestos rapid screening system according to another embodiment of the disclosure. Referring to FIG. 1 at the same time, the difference between the asbestos rapid screening system 100′ in FIG. 2 and the asbestos rapid screening system 100 in FIG. 1 is that the storage device 302 of the asbestos rapid screening system 100′ in FIG. 2 including the asbestos identification model 303 is communicatively connected to the spectrometer 101 and is disposed in the cloud server 300 to perform asbestos identification in the cloud server 300.

Specifically, the operating device 200 transmits the spectral data SD of the object to be tested D to the cloud server 300. The cloud server 300 includes a processor 301 and a storage device 302. The storage device 302 of the cloud server 300 has an asbestos identification model 303, and in the cloud server 300, the spectral data SD of the object to be tested D is identified using the asbestos identification model 303 to determine whether the object to be tested D contains asbestos. The cloud server 300 transmits a generated identification result IR to the operating device 200, and a display screen of the operating device 200 is used to display the identification result IR to a user. In addition, the storage device 302 may further include a database 304 for storing spectral data of various asbestos.

In some embodiments, the asbestos identification model 303 is executed using the processor 301 of the cloud server 300 to identify the spectral data SD of the object to be tested D. In some embodiments, the asbestos identification model 303 of the cloud server 300 is executed using the processor 301 of the operating device 200.

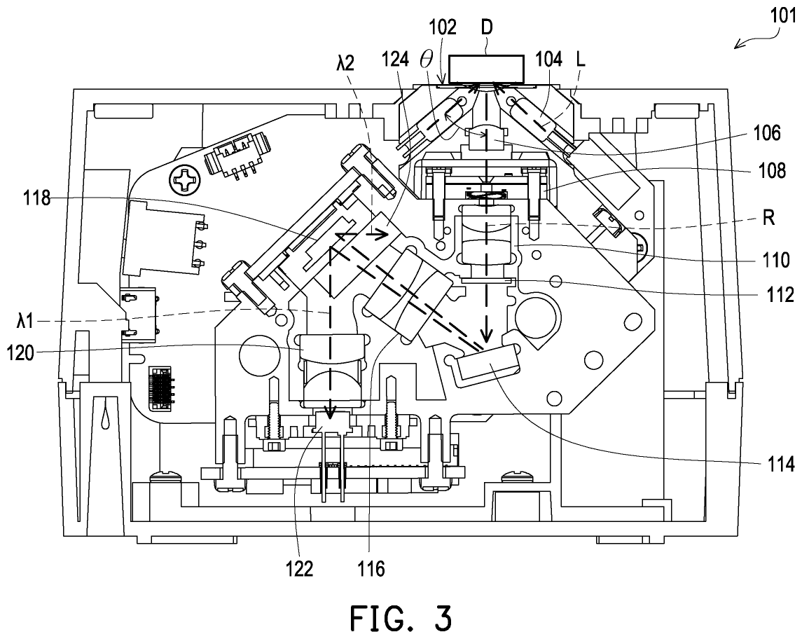

FIG. 3 is a schematic diagram of the interior of a spectrometer 101 of an asbestos rapid screening system according to an embodiment of the disclosure. In this embodiment, the spectrometer 101 adopts the digital light processing (DLP) technology. The spectrometer 101 includes a scanning window 102, a light source 104, a diffraction grating 114, a wavelength selector 118, a light absorbing element 124, and a photodetector 122. The object to be tested D is placed above the scanning window 102. In some embodiments, the housing of the spectrometer 101 is formed by plastic injection molding technology. In some embodiments, the scanning window 102 includes scratch-resistant sapphire glass.

The light source 104 is configured to provide light L to the object to be tested D above the scanning window 102. In this embodiment, the light source 104 is, for example, a vacuum tungsten lamp, a laser light source, a light-emitting diode (LED), or other suitable light sources. During the process of the spectrometer 101 scanning the object to be tested D, the light source 104 emits the light L. The dominant wavelength of the light L is preferably within the range of 900 nanometers to 1700 nanometers. The light L passes through the scanning window 102 and irradiates toward the object to be tested D. The light L is absorbed, transmitted, and diffuse reflected at the object to be tested D, in which at least a portion of the light L is reflected by the object to be tested D and generates a diffuse reflected light R. In some embodiments, an included angle θ between the light L emitted by the light source 104 and a normal vector of the scanning window 102 is within a range of 40 degrees to 50 degrees.

The diffuse reflected light R passes through a collection lens group 106, an entrance slit module 108, a collimating lens group 110, a bandpass filter 112, and a diffraction grating 114 in sequence. The diffuse reflected light R is incident on the diffraction grating 114.

In some embodiments, the entrance slit module 108 may be formed by electroforming or laser processing. In some embodiments, the entrance slit module 108 includes a slit with a width of about 20 microns to 30 microns, such as 25 microns.

In some embodiments, the bandpass filter 112 is manufactured by coating a light-transmissive substrate, and the bandpass filter 112 may exclude light with a wavelength of 900 nanometers and below.

The diffraction grating 114 divides the diffuse reflected light R into multiple sub-diffuse reflected lights λ1 and λ2 of different wavelengths. The sub-diffuse reflected lights λ1 and λ2 pass through focusing lens group 116 and are incident on the wavelength selector 118. In some embodiments, the diffraction grating is a reflective diffraction grating or a transmissive diffraction grating having multiple grooves. The grooves are arranged along an arrangement direction at a number of 300 to 1200 per millimeter. For example, in some embodiments, the width of the groove is 3.33 microns. In some embodiments, the diffraction grating 114 is a holographic diffraction grating, which achieves the purpose of dividing the diffuse reflected light R into multiple sub-diffuse reflected lights λ1 and λ2 of different wavelengths through periodic changes in bright and dark interference fringes.

The photodetector 122 and the light absorbing element 124 are configured to receive light from the wavelength selector 118. The wavelength selector 118 is configured to allow at least one of the sub-diffuse reflected lights λ1 and λ2 to be incident on and pass through the converging lens group 120 and then be received by the photodetector 122, and at least another one of the sub-diffuse reflected lights λ1 and λ2 to be incident on the light absorbing element 124. In some embodiments, the sub-diffuse reflected lights λ1 and λ2 are respectively incident on and pass through the converging lens group 120 according to timings and are then received by the photodetector 122. For example, in a first timing, the wavelength selector 118 allows the sub-diffuse reflected light λ1 to pass through the converging lens group 120 and be incident on the photodetector 122, and simultaneously allows the sub-diffuse reflected light λ2 to be incident on the light absorbing element 124 and then be absorbed. In a second timing, the wavelength selector 118 allows the sub-diffuse reflected light λ2 to pass through the converging lens group 120 and be incident on the photodetector 122, and simultaneously allows the sub-diffuse reflected light λ1 to be incident on the light absorbing element 124 and then be absorbed.

In some embodiments, the photodetector 122 is a single-point photodetector. In some embodiments, the photodetector 122 includes a PIN type photodiode, and the material thereof includes, for example, InGaAs. The photodetector 122 may also include other types of photodiodes. In some embodiments, the spectral resolution of the spectrometer 101 is on average 10 nm.

In some embodiments, the light absorbing element 124 is, for example, a near infrared absorber to prevent light from being reflected inside the spectrometer 101 and causing stray light, thereby significantly improving the signal to noise ratio (SNR) of the spectrometer 101 and ensuring the accuracy of spectral data. In some embodiments, the light absorbing element 124 includes carbon black or other similar light absorbing materials. The light absorbing material is coated on a preformed aluminum substrate and then assembled into the spectrometer 101 to absorb the light reflected by the wavelength selector 118.

In some embodiments, the wavelength selector 118 includes a digital micro-mirror device (DMD) or a liquid-crystal-on-silicon panel (LCOS panel). In some embodiments, the wavelength selector 118 may perform wavelength selection for near infrared light of wavelengths between 900 nanometers and 2500 nanometers.

In one embodiment, the collection lens group 106, the collimating lens group 110, the focusing lens group 116 and the converging lens group 120 preferably adopt optical glass, and the surfaces of the optical glass may be coated with an anti-reflection film of the near infrared wavelength range.

In some embodiments, the spectrometer 101 further includes a control circuit board. The control circuit board includes a microprocessor and memory, a wavelength selector controller, a USB communication interface, a universal asynchronous receiver/transmitter (UART) communication interface, a wireless communication interface including Bluetooth low energy (BLE), a battery and light source control circuit, a transimpedance amplifier (TIA) and analog-to-digital converter for the photodetector, a temperature sensor, a humidity sensor, keys, and indicator lights.

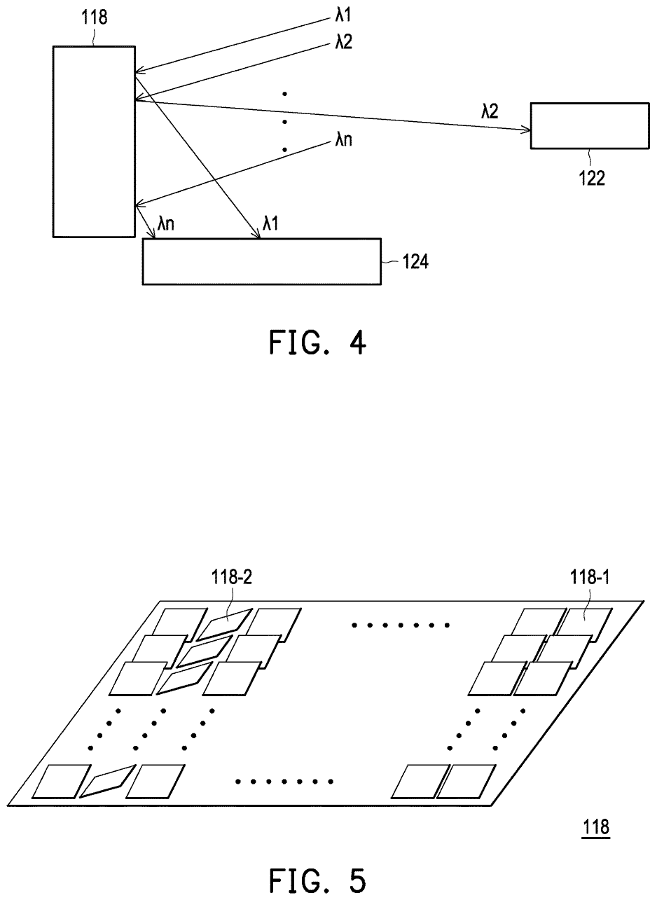

FIG. 4 is a schematic diagram of the transmission of the sub-diffuse reflected lights λ1 and λ2. Referring to FIG. 3 to FIG. 4, in this embodiment, the wavelength selector 118 and the light absorbing element 124 are located on the transmission paths of the sub-diffuse reflected lights λ1 and λ2. In the second timing, the light absorbing element 124 is located on the transmission path where the sub-diffuse reflected lights λ1 and λ3 . . . . An are reflected by the wavelength selector 118, except for the sub-diffuse reflected light λ2. In the second timing, the sub-diffuse reflected light λ2 is reflected by the wavelength selector 118 to the photodetector 122. In addition, in the first timing, the light absorbing element 124 is located on the transmission path where the sub-diffuse reflected lights λ2 and λ3 . . . λn are reflected by the wavelength selector 118, except for the sub-diffuse reflected light λ1. In the first timing, the sub-diffuse reflected light λ1 is reflected by the wavelength selector 118 to the photodetector 122. The other sub-diffuse reflected lights are reflected by the wavelength selector 118 to the single-point photodetector 122 according to timings.

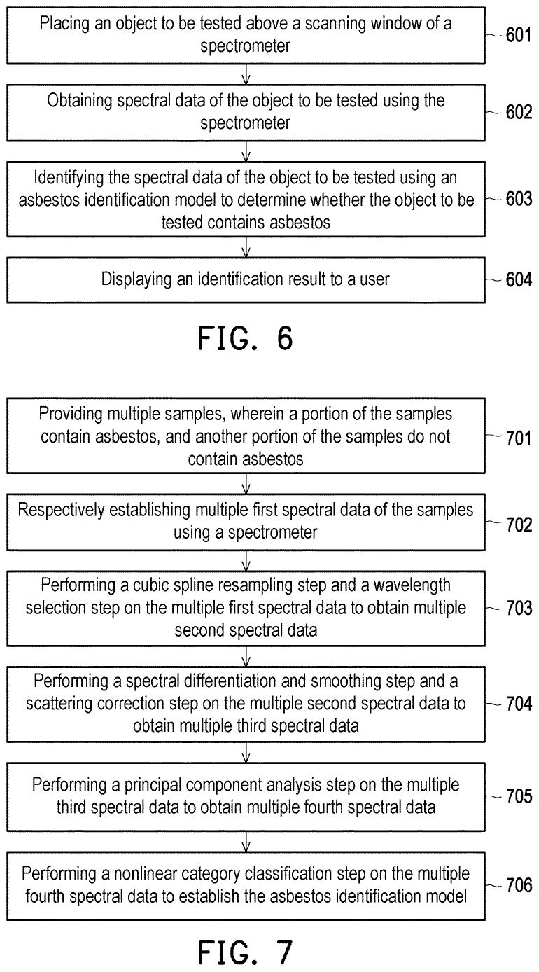

FIG. 5 is a schematic diagram of a wavelength selector 118 controlling the deflection of its micro-mirrors at different timings. In this embodiment, the wavelength selector 118 includes a digital micro-mirror device (DMD). The digital micro-mirror device has multiple micro-mirrors arranged in an array, and the sub-diffuse reflected lights λ1 and λ2 are respectively incident on different micro-mirrors 118-1 and 118-2 of the wavelength selector 118. In some embodiments, the digital micro-mirror device includes 854×480 micro-mirrors.

The deflection directions of the micro-mirrors 118-1 and 118-2 may be controlled through software, hardware, or other means. For example, when each micro-mirror 118-2 is controlled to be in an ON state, as shown in FIG. 5, at the first timing, the sub-diffuse reflected light λ1 incident on the micro-mirror 118-2 is reflected to the photodetector 122. On the contrary, for the other micro-mirrors 118-1 controlled to be in an OFF state, the incident sub-diffuse reflected light λ2 is reflected to the light absorbing element 124. In some embodiments, the micro-mirrors are controlled to rotate 17 degrees in the ON state, and the micro-mirrors are controlled to rotate −17 degrees in the OFF state, but the disclosure is not limited thereto.

In this embodiment, the wavelength selector 118 is controlled to respectively output multiple sub-diffuse reflected lights in different wavelength ranges at multiple different timings, and the photodetector 122 integrates the received signals at different timings to obtain the spectral data of the object to be tested. That is, each of the micro-mirrors 118-1 and 118-2 in the wavelength selector 118 is controlled to be in the ON state at different timings, so that the sub-diffuse reflected lights λ1 and λ2 are reflected to the photodetector 122 at different timings according to their wavelength ranges.

In some embodiments, the width and length of each of the micro-mirrors 118-1 and 118-2 are 4 microns to 7 microns, for example, the width and length are both 5.4 microns.

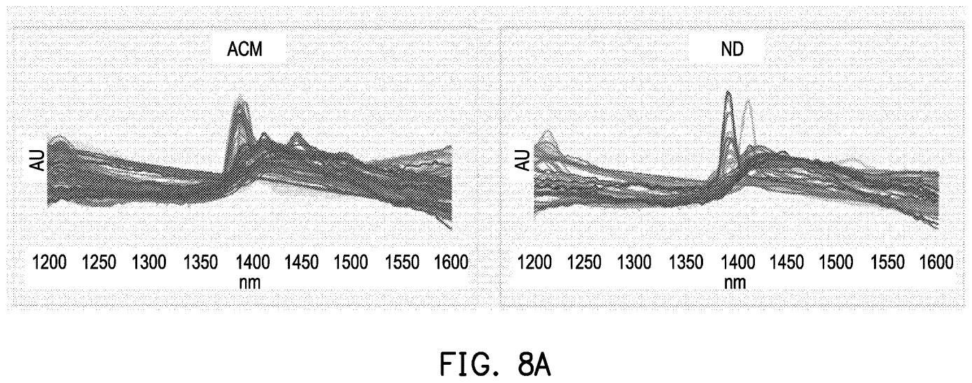

FIG. 6 is a flowchart of a detection method of an asbestos rapid screening system of an embodiment of the disclosure. Referring to FIG. 6, in step 601, the object to be tested is placed above a scanning window of a spectrometer. In step 602, spectral data of the object to be tested is obtained using the spectrometer. In step 603, the spectral data of the object to be tested is identified using an asbestos identification model to determine whether the object to be tested contains asbestos. In step 604, an identification result is displayed to a user.

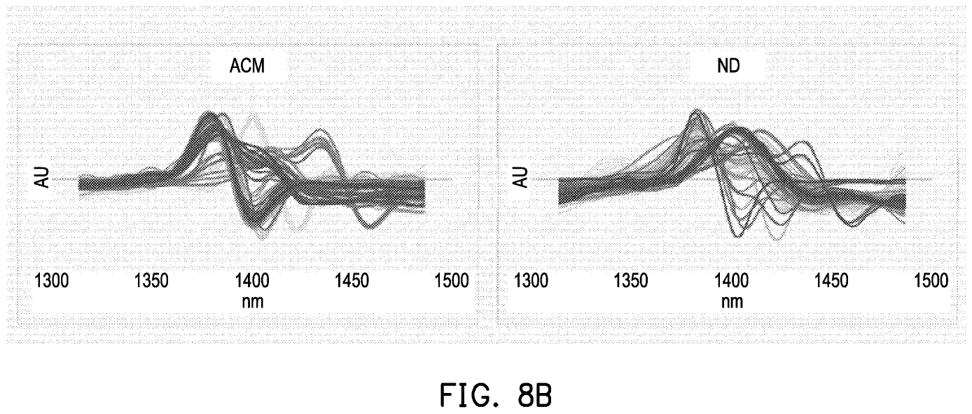

FIG. 7 is a flowchart of a forming method of an asbestos identification model of an embodiment of the disclosure. For example, FIG. 7 shows a forming method of the asbestos identification model 203 in FIG. 1 or the asbestos identification model 303 in FIG. 2. Referring to FIG. 7, in step 701, multiple samples are provided, in which a portion of the samples contain asbestos, and another portion of the samples do not contain asbestos. In some embodiments, the asbestos in the samples includes at least one of actinolite, amosite, anthophyllite, chrysotile, crocidolite and tremolite, in which chrysotile is also known as white asbestos.

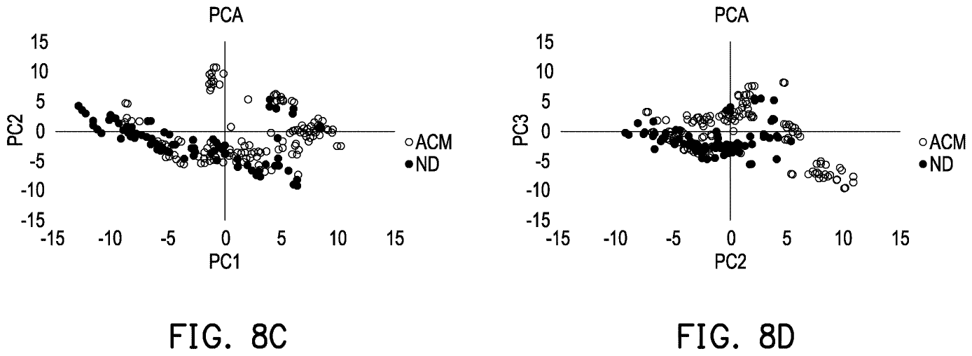

In step 702, multiple first spectral data of the samples are respectively established using a spectrometer, in which each of the samples corresponds to a corresponding one of the first spectral data. For example, multiple first spectral data of multiple samples are established using the spectrometer 101 in the asbestos rapid screening system shown in FIG. 1 or FIG. 2. The first spectral data of the samples are collected and labeled. For example, the first spectral data of the sample containing asbestos is labeled as ACM, and the first spectral data of the sample not containing asbestos is labeled as ND, as shown in FIG. 8A. In FIG. 8A, there are 3599 records of the first spectral data for sample containing asbestos, and there are 1350 records of the first spectral data for sample not containing asbestos. In FIG. 8A, the vertical axis represents absorbance unit (AU), and the horizontal axis represents wavelength (in nanometers).

Next, in step 703, a cubic spline resampling step and a wavelength selection step are performed on the first spectral data to obtain multiple second spectral data. The purpose of the cubic spline resampling step is to ensure uniform distribution of values across each wavelength in the spectral data, thereby facilitating subsequent processing.

The wavelength range selected in the wavelength selection step is between 1300 nanometers and 1500 nanometers (or 1350 nanometers and 1450 nanometers), and subsequent processing is performed for the selected wavelength range.

In some embodiments, the wavelength selection step may be performed simultaneously with the cubic spline resampling step, but the disclosure is not limited thereto. In some embodiments, the wavelength selection step is performed before or after the cubic spline resampling step.

In step 704, a spectral differentiation and smoothing step and a scattering correction step are performed on the second spectral data to obtain multiple third spectral data. The scattering correction step may be performed before or after the spectral differentiation and smoothing step. FIG. 8B shows multiple third spectral data obtained after multiple first spectral data of FIG. 8A undergoes cubic spline resampling, a wavelength selection step, a spectral differentiation and smoothing step, and a scattering correction step.

In some embodiments, the spectral differentiation and smoothing step may extract spectral features and suppress spectral noise. For example, the spectral differentiation and smoothing step is performed using Savitzky-Golay derivative or gap segment derivative.

In some embodiments, the scattering correction step may correct for scattering effects of the sample. For example, the scattering correction step is performed using standard normal variate (SNV) or multiplicative scatter correction (MSC).

In step 705, a principal component analysis step is performed on the third spectral data to obtain multiple fourth spectral data. Principal component analysis (PCA) may transform spectra into an orthogonal coordinate system and reduce the dimensionality of spectral data. Each fourth spectral data is represented by multiple principal components PC1, PC2, PC3 and so on. FIG. 8C shows a distribution diagram of multiple fourth spectral data with the principal component PC1 as the horizontal axis and the principal component PC2 as the vertical axis. FIG. 8D shows a distribution diagram of multiple fourth spectral data with the principal component PC2 as the horizontal axis and the principal component PC3 as the vertical axis. However, it should be noted that the fourth spectral data generated after the principal component analysis step is performed on each third spectral data may not only include the three principal components PC1, PC2, PC3, but may include more principal components.

In step 706, a nonlinear (category) classification step is performed on the fourth spectral data to establish an asbestos identification model. In some embodiments, the nonlinear classification step is performed using a support vector machine (SVM), an artificial neural network (ANN), or other machine learning and artificial intelligence algorithms.

In some embodiments, a linear classification is performed on the fourth spectral data to establish an asbestos identification model, in which the linear classification may also be referred to as linear discriminant analysis (LDA). The asbestos identification model established by the linear classification and the asbestos identification model established by the nonlinear classification are implemented in the asbestos rapid screening system (as shown in FIG. 1), and the accuracy of these two asbestos identification models is tested, as shown in Table 1 below. In Table 1, 4949 samples were analyzed using different asbestos identification models, of which 3599 samples contained asbestos, while 1350 samples did not contain asbestos. In Table 1, samples containing asbestos are shown as ACM, and samples not containing asbestos are shown as ND.

TABLE 1

| | Asbestos identification | | Asbestos identification | |
|---|---|---|---|---|
| | model established by | | model established by | |
| | linear classification | | nonlinear classification | |
| | Determined | Determined | Determined | Determined |
| | as ACM | as ND | as ACM | as ND |
| Actually | 3439 | 160 | 3599 | 0 |
| ACM | | | | |
| Actually ND | 131 | 1219 | 0 | 1350 |

It may be seen from Table 1 that the asbestos identification model established using linear classification demonstrates an accuracy of approximately 95% for true positives (where samples are actually ACM and are also determined to be ACM), while the accuracy for true negatives (where samples are actually ND and are also determined to be ND) is only approximately 90%. However, under the same pre-processing conditions, the asbestos identification model established using nonlinear classification has an accuracy of 100% for both true positives and true negatives. Based on this, it may be determined that the asbestos identification model established using nonlinear classification possesses the advantage of high accuracy.

To sum up, the asbestos identification model of the disclosure uses nonlinear classification to process data, the asbestos rapid screening system including the asbestos identification model may quickly and accurately determine whether the object to be tested contains asbestos.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A forming method of an asbestos identification model, comprising:
providing a plurality of samples, wherein a portion of the plurality of samples contain asbestos, and another portion of the plurality of samples do not contain the asbestos;
respectively establishing a plurality of first spectral data of the plurality of samples using a spectrometer, wherein each of the plurality of samples corresponds to a corresponding one of the plurality of first spectral data;
performing a cubic spline resampling step and a wavelength selection step on the plurality of first spectral data to obtain a plurality of second spectral data, wherein a wavelength range selected in the wavelength selection step is between 1300 nanometers and 1500 nanometers;
performing a spectral differentiation and smoothing step and a scattering correction step on the plurality of second spectral data to obtain a plurality of third spectral data, wherein the scattering correction step is performed before or after the spectral differentiation and smoothing step;
performing a principal component analysis step on the plurality of third spectral data to obtain a plurality of fourth spectral data; and
performing a nonlinear classification step on the plurality of fourth spectral data to establish the asbestos identification model.

2. The forming method of the asbestos identification model according to claim 1, wherein the nonlinear classification step is performed using a support vector machine or an artificial neural network.

3. The forming method of the asbestos identification model according to claim 1, wherein the spectral differentiation and smoothing step is performed using Savitzky-Golay derivative or gap segment derivative.

4. The forming method of the asbestos identification model according to claim 1, wherein the scattering correction step is performed using standard normal variate or multiplicative scatter correction.

5. An asbestos rapid screening system, comprising:
a spectrometer, comprising a scanning window, a light source, a diffraction grating, a wavelength selector, a photodetector, and a light absorbing element, wherein the light source is configured to provide light to an object to be tested above the scanning window, wherein at least a portion of the light is reflected by the object to be tested and then passes through the diffraction grating and the wavelength selector in sequence, and the photodetector and the light absorbing element are configured to receive light from the wavelength selector; and
a storage device, communicatively connected to the spectrometer, wherein the storage device comprises an asbestos identification model, and the asbestos identification model comprises asbestos data processed by nonlinear classification.

6. The asbestos rapid screening system according to claim 5, wherein the spectrometer further comprises:
a collection lens group, an entrance slit module, a collimating lens group, a bandpass filter, a focusing lens group, and a converging lens group, wherein
the object to be tested receives the light emitted by the light source and generates diffuse reflected light, the diffuse reflected light passes through the collection lens group, the entrance slit module, the collimating lens group, the bandpass filter and the diffraction grating in sequence, the diffraction grating divides the diffuse reflected light into a plurality of sub-diffuse reflected lights of different wavelengths;
the plurality of sub-diffuse reflected lights pass through the focusing lens group and are incident on the wavelength selector; and
the wavelength selector is configured to allow at least one of the plurality of sub-diffuse reflected lights to be incident on and pass through the converging lens group and then be received by the photodetector, and at least another one of the plurality of the sub-diffuse reflected lights to be incident on the light absorbing element.

7. The asbestos rapid screening system according to claim 6, wherein the entrance slit module comprises a slit with a width of about 20 microns to 30 microns, wherein the diffraction grating has a plurality of grooves, wherein the plurality of grooves are arranged along an arrangement direction at a number of 300 to 1200 per millimeter, the wavelength selector comprises a digital micro-mirror device having a plurality of micro-mirrors arranged in an array, a width and a length of each of the plurality of micro-mirrors are 4 microns to 7 microns.

8. The asbestos rapid screening system according to claim 5, wherein the storage device is disposed in a mobile device or a cloud server.

9. The asbestos rapid screening system according to claim 5, wherein an included angle between the light emitted by the light source and a normal vector of the scanning window is in a range of 40 degrees to 50 degrees.

10. A detection method of an asbestos rapid screening system, comprising:
providing the asbestos rapid screening system according to claim 5;
placing the object to be tested above the scanning window;
obtaining spectral data of the object to be tested using the spectrometer; and
identifying the spectral data of the object to be tested using the asbestos identification model to determine whether the object to be tested contains asbestos.

11. The detection method of the asbestos rapid screening system according to claim 10, wherein a forming method of the asbestos identification model comprises:
providing a plurality of samples, wherein a portion of the plurality of samples contain the asbestos, and another portion of the plurality of samples do not contain the asbestos;
establishing a plurality of first spectral data of the samples, wherein each of the plurality of samples corresponds to a corresponding one of the plurality of first spectral data;
performing a cubic spline resampling step and a wavelength selection step on the first spectral data to obtain a plurality of second spectral data, wherein a wavelength range selected in the wavelength selection step is between 1300 nanometers and 1500 nanometers;
performing a spectral differentiation and smoothing step and a scattering correction step on the plurality of second spectral data to obtain a plurality of third spectral data, wherein the scattering correction step is performed before or after the spectral differentiation and smoothing step;
performing a principal component analysis step on the plurality of third spectral data to obtain a plurality of fourth spectral data; and
performing a nonlinear classification step on the plurality of fourth spectral data to establish the asbestos identification model.

12. The detection method of the asbestos rapid screening system according to claim 10, further comprising:
issuing a control command using a mobile device to enable the spectrometer to scan the object to be tested to obtain the spectral data.

13. The detection method of the asbestos rapid screening system according to claim 12, wherein the asbestos identification model is located in the mobile device or a cloud server.
